(19) United States
(12) Patent Application Publication
(10) Pub. No.: US 2025/0305603 A1
(43) Pub. Date: Oct. 2, 2025

(54) Fitting and Method of Making the Same

(71) Applicant: Indimet Inc., White Plains, NY (US)

(72) Inventors: Rochan S. Mehta, White Plains, NY (US); Shreyas R. Mehta, White Plains, NY (US)

(73) Assignee: Indimet Inc., White Plains, NY (US)

(21) Appl. No.: 18/624,474

(22) Filed: Apr. 2, 2024

(51) Int. Cl. F16L 19/02

(52) U.S. Cl. CPC F16L 19/0225

(57) ABSTRACT

The present invention relates to an improved fitting and a method of making the same. The fitting is made via a cold-forging method which decreases fabrication complexity by eliminating multi-component fabrication and assembling, while increasing operational performance of the product.

### FIELD OF THE INVENTION

The present invention relates to a fitting and a method of making the fitting.

### BACKGROUND OF THE INVENTION

Fittings are typically used to facilitate the flow of fluids. They may be used in a wide range of environments, from residential and commercial buildings to small and heavy industries. Integrated hose or pipe systems are generally employed there so that fluids can be circulated for a variety of uses. Fittings may be necessary to join various pieces of the hose or pipe. It is desirable that they are versatile so that they can adapt to different hose/pipe shapes and directions. However, corrosive environments, extreme high and extreme low temperatures, may present very tough challenges for conventional fittings. Especially in high-pressure applications, the stress may be even more and may push the conventional fittings to the brink of a collapse.

Conventional fittings in larger sizes usually do not provide an adequate pressure rating. Also, conventional fittings typically use O-ring sealings, which may also be susceptible to erosion. Furthermore, O-ring sealings are generally not expected to withstand higher temperature and pressure. Most of the O-ring seals now-a-days used, are elastomeric. The severity of pressure and temperature conditions or corrosive environments may lead to inevitable wear and tear on the elastomeric seals. Usually, when the condition is more intense, the deterioration is more premature. Even before identifying the deterioration, leaks may happen. In certain circumstances, leakage may pose serious financial and security threats. In such extreme conditions equipment downtime may also become a very frequent and expensive issue.

What is desired, therefore, is a fitting, which can tolerate both extreme pressure and extreme temperature as well as can effectively prevent leaks. The improved fitting should also have an increased operational lifetime over the prior art. It is further desired that the method of making the fitting eliminates the structural and fabrication complexity of the prior art. It is also desirable that the method of providing the fitting is inexpensive, finely tunable and precise.

### SUMMARY OF THE INVENTION

It is therefore an object of this invention to provide a fitting via a cold-forging method which decreases fabrication complexity by eliminating multi-component fabrication and assembling, while increasing operational performance of the product. It is a further object of the invention to provide a fitting with a simplified, integral construction that can nonetheless be used in high-performance applications. It is yet another object of this invention to provide a fitting consistent with the above objects which can be consistently made to exacting specifications to allow for enhanced operational lifetimes.

The instant invention relates to a method of making a fitting comprising the steps of providing a solid cylinder having a perimeter, extending said perimeter to form a raised wall with a front end and a back end, extending a shaft from said front end to said back end in an axial direction, and shaping said raised wall and said shaft to form a hollow space in between an outer surface of said shaft and an inner surface of said raised wall, wherein said raised wall and said shaft are integrally connected at said front end as a single piece.

In one preferred embodiment, the method further comprises the step of providing a diameter of said front end to be less than a diameter of said back end. On the other hand, in another embodiment, the method comprises providing a diameter of said front end to be greater than said back end. In a further embodiment, the method comprises the step of forming at least one protrusion in between said shaft and said raised wall at said front end. In some embodiments, the method comprises the step of extending said shaft beyond said back end of said raised wall. In yet some embodiments, said shaft is extended but it ends before the back end of said raised wall.

In all embodiments, said shaft and said front end are hollowed out to form a hollow shaft. In one embodiment, the method further comprises the step of extending said front end. In a further embodiment, the method comprises the step of shaping a lower portion of said front end to have a polygonal shape. In yet further embodiments, the method comprises the step of shaping an outer surface of an upper portion of said front end to have threads.

In some embodiments, the method comprises the step of shaping an inner surface of said back end to have grooves. In other embodiments the method comprises the step of shaping an outer surface of said hollow shaft to have threads. Yet in some embodiments the method comprises both the step of shaping an outer surface of said hollow shaft to have threads and the step of shaping an inner surface of said back end to have grooves.

The present invention also relates to a method of making a fitting comprising the steps of providing a solid cylinder having a perimeter, extending said perimeter to form a raised wall with a front end and a back end, extending a shaft from said front end to said back end in an axial direction, shaping said raised wall and said shaft to form a hollow space in between an outer surface of said shaft and an inner surface of said raised wall, wherein said raised wall and said shaft are integrally connected at said front end as a single piece, providing a diameter of said front end to be less than a diameter of said back end, forming at least one protrusion in between said shaft and said raised wall at said front end, extending said front end, hollowing out said shaft and said front end to form a hollow shaft, shaping a lower portion of said front end to have a polygonal shape, and shaping an outer surface of an upper portion of said front end to have threads.

The method further comprises the step of providing a nut and the step of crimping said nut onto said upper portion of said front end, wherein said nut is permanently attached to said upper portion of said front end but flows freely around the threads.

In some embodiments, the method comprises the step of shaping an inner surface of said back end to have grooves. In other embodiments, the method comprises the step of shaping an outer surface of said hollow shaft to have threads. Yet in some embodiments, the method comprises both the step of shaping an outer surface of said hollow shaft to have threads and the step of shaping an inner surface of said back end to have grooves.

The present invention also relates to a method of making a fitting comprising the steps of providing a solid cylinder, forming a disk with a perimeter, extending a shaft perpendicular to and from the center of the disk towards two opposite directions, shaping a portion of the outer surface at the back end of the shaft to have threads, extending the perimeter of the disk to form a raised wall, forming at least one protrusion in between the shaft and the raised wall, hollowing out the shaft to form a hollow shaft, and shaping the outer surface of the upper portion at the front end of the hollow shaft to have threads. In some further embodiments, the method comprises the steps of providing a nut, and crimping the nut onto the upper portion of the front end.

In one embodiment, the invention also relates to fitting comprising an outside housing, having an inner surface and an outer surface; a hollow shaft, having an inner surface and an outer surface, wherein said hollow shaft penetrates through said outside housing in an axial direction as well as wherein said outside housing has a front end with a smaller diameter and a back end with a larger diameter; wherein a diameter of said hollow shaft is smaller than said larger diameter of said back end of said outside housing; at least one protrusion extending from said outer surface of said hollow shaft to said inner surface of said outside housing to form a sealing. In a further embodiment, the protrusion is perpendicular to said outside housing and said hollow shaft. In yet another embodiment, the protrusion is not perpendicular to said outside housing and said hollow shaft.

In one embodiment, the fitting is made of metal. In another embodiment, the fitting is made of metal alloy. In yet another embodiment the fitting is made of carbon steel. The fitting is made of stainless steel in most embodiments.

In some embodiments the hollow shaft extends beyond the back end of the outside housing. In other embodiments, the outside housing extends beyond the hollow shaft. In yet some other embodiments, the hollow shaft ends where the back end of the outside housing ends.

In a further embodiment, a portion of said outer surface at said front end of said outside housing is threaded to attach a securing mechanism. In other embodiments, a free-flowing nut is attached permanently on said front end to attach a securing mechanism.

In one embodiment, a portion of said inner surface at said back end of said outside housing is grooved to attach a securing mechanism. In another embodiment, a portion of said outer surface of said hollow shaft is threaded to attach a securing mechanism. In yet another embodiment, both a portion of said inner surface at said back end of said outside housing is grooved and a portion of said outer surface of said hollow shaft is threaded to attach a securing mechanism.

### BRIEF DESCRIPTION OF THE DRAWINGS

The features of the invention are believed to be novel and the elements characteristic of the invention are set forth with particularity in the claims. The figures are for illustration purposes only. The invention itself, however, both as to organization and method of operation, may be understood by reference to the detailed description which follows taken in conjunction with the accompanying drawings in which the drawings show typical embodiments of the invention and are not intended to be limited of its scope.

FIG. 1 shows a flowchart depicting a method of making a fitting consistent with one embodiment of the instant invention.

FIG. 2 shows a flowchart depicting a further embodiment of the method of making a fitting from FIG. 1.

FIG. 3 shows a flowchart depicting a further embodiment of the method of making a fitting from FIG. 1.

FIG. 4 shows a flowchart depicting a further embodiment of the method of making a fitting from FIG. 1.

FIG. 5 shows a flowchart depicting a further embodiment of the method of making a fitting from FIG. 1.

FIG. 6 shows cross-section of each resulting interim structure after steps 105, 135, and 155 of the method in FIG. 1.

FIG. 7 shows a flowchart depicting a method of making a fitting consistent with another embodiment of the instant invention.

FIG. 8 shows cross-section of each resulting interim structure after steps 705, 715, 720, and 735 of the method in FIG. 7.

FIG. 9 depicts a side view consistent with one embodiment of the fitting.

FIG. 10 depicts a top view of the fitting in FIG. 9.

FIG. 11 depicts a bottom view of the fitting in FIG. 9.

FIG. 12 depicts a top-to-bottom cross-sectional view of the fitting in FIG. 9.

FIG. 13 depicts a side view consistent with another embodiment of the fitting.

FIG. 14 depicts a top view of the fitting in FIG. 13.

FIG. 15 depicts a bottom view of the fitting in FIG. 13.

FIG. 16 depicts a top-to-bottom cross-sectional view of the fitting in FIG. 13.

FIG. 17 depicts a top-to-bottom cross-sectional view consistent with another embodiment of the fitting.

FIG. 18 depicts a top-to-bottom cross-sectional view consistent with yet another embodiment of the fitting.

### DETAILED DESCRIPTION OF THE INVENTION

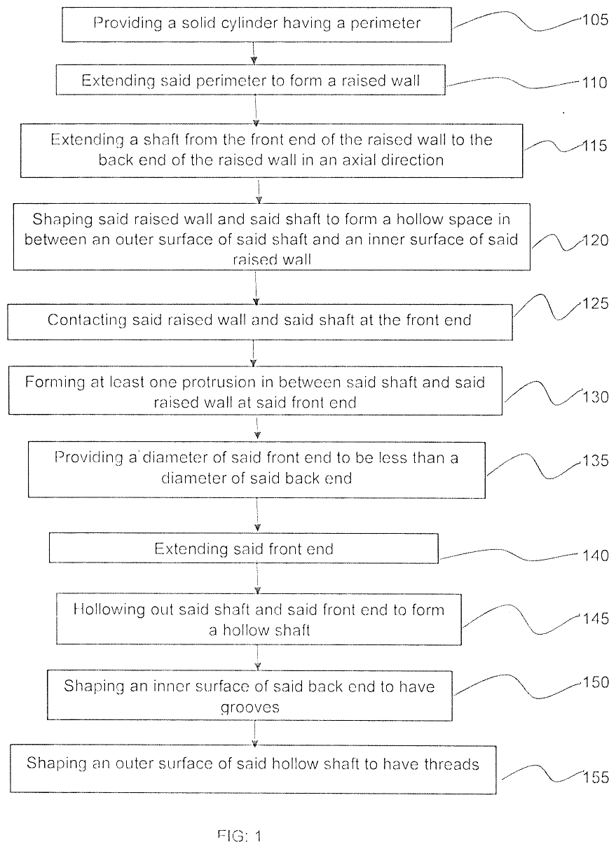

In describing the various embodiments of the instant invention, reference will be made herein to FIGS. 1-18 in which like numerals refer to like features of the invention.

The instant invention generally relates to an improved fitting and a novel method of making the fitting. In one embodiment of the instant invention, a cold-forging method has been found which allows for simplified fabrication of the fitting as a one-piece construction from a single billet of malleable material. Cold forging from a single cylinder minimizes material loss typically associated with cutting or machining, which results in waste by removal of material. This also reduces the manufacturing time and complexity associated with assembly, cutting, drilling, and machining of traditional fitting. A further advantage is the elimination of joints and seams caused by prior art welding or nesting methods of fabricating a composite structure. These joints and seams inherently introduce weak points which lead to shorter operational lifetimes and lower tolerances to stress.

FIG. 1 depicts a method of making a fitting consistent with one embodiment of the instant invention. FIG. 1 shows the step (105) of providing a solid cylinder of malleable material having a perimeter. The cylinder is comprised of any malleable material suitable for use as a fitting. The cylinder is already annealed and lubricated. In most embodiments, the malleable material is a stainless steel. Fittings made with stainless still is mostly used in corrosive environments, especially if the fluid passing through the fitting, is corrosive. The applicant has advantageously found that 304 stainless steel provides the best performance in corrosive environments. In other embodiments the malleable material is a carbon steel. 1010 steal is mostly used for carbon steel embodiments. However, instead of 1010, 1020 is also used in some embodiments, where the carbon content is a little bit higher (approximately 0.2%). Herein, the cylinder of malleable material and all method steps for modifying said cylinder of malleable material will be described and portrayed as having a basic, curved cylindrical shape; that is to say that the ends of the cylinder are circles. However, the specific shape of the cylinder is not meant to be limited to this embodiment. In other embodiments, the outline of the cylinder is selected from the group comprising of a square, rectangle, triangle, pentagon, hexagon, octagon, and polygon. The specific shape of the cylinder of malleable material is a design choice well within the abilities of one of ordinary skill in the art. The cylinder is subjected to the various cold-forging and machining steps that will be described herein.

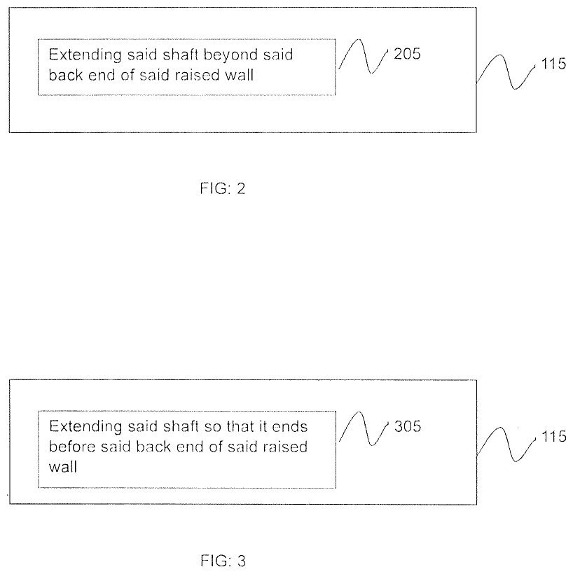

After the cylinder is provided (105), the perimeter is extended to form a raised wall (110). This is done by placing the cylinder in a die, and a punch is pressed downwards into the material, extruding a raised wall upwards from the perimeter of the solid cylinder. The height of the raised wall is a function of the amount of material in the cylinder and the desired design of the fitting. This results in a hollow cylinder with an open back end and a closed front end, which is then placed in another die and a punch is pressed upward. This way, a shaft is extended from the front end to the back end in an axial direction (115). As shown in FIG. 2, in one embodiment, the shaft is extended beyond the back end of the raised wall (205). However, as shown in FIG. 3, in another embodiment, the shaft is extended but it is limited to end before the back end of the raised wall (305). Which embodiment to use depends on the application of the fitting. Still in some embodiments, the shaft extends only until the back end of the raised wall. The length of the shaft as well as the length of the raised wall also vary considerably in further embodiments.

Coming back to FIG. 1, the resulting product is then placed in another die to shape the raised wall and the shaft (120). They are shaped in a way that a hollow space is formed in between an outer surface of the shaft and an inner surface of the raised wall. The volume and shape of the hollow space is dependent on the shape of the die. Different shapes of the die results in different embodiments. It is ultimately dependent on the designer's choice, cost and manufacturer's need.

By using a die, a high pressure is applied at the front end so that the shaft and the raised wall are integrally connected at the front end as a single piece (125).

In the next step (130), the interim product is then entered into a die through the back end and a high pressure is applied. This way a protrusion is formed in between the shaft and the raised wall at the front end. In most embodiments, the protrusion is generally perpendicular to the shaft and the raised wall. However, in some embodiments, the protrusion is not perpendicular to the shaft and the raised wall. This is done just by slightly changing the shape of the die. Thickness of the protrusion is a function of the amount of material and the desired design of the fitting. Typically, in high pressure applications, thicker protrusion is desired. The thicker the protrusion is, the higher pressure the fitting can tolerate. However, cost is also a factor in the design. That is why, in different embodiments, thicknesses of the protrusions are different. For example, in some embodiments, the protrusion is 1 millimeter (mm) thick while in some other embodiments the protrusion is 5 millimeters (mm) thick. In most embodiments, the protrusion touches the inner surface of the raised wall. Still in one embodiment, protrusion does not touch the inner surface of the raised wall.

After step 130, the front end is then pressed into a die to shape the front end so that its diameter is smaller than the diameter of the back end (135). However, in some embodiments, the front end is pressed into a different die so that the front end's diameter is greater than the diameter of the back end. Diameters of both the front end and the back end are dependent on manufacturer's design choice and customers' needs. Diameters of the front end and the back end varies significantly in different embodiments. For example, in some embodiments, diameter of the front end is 75% of the diameter of the back end while in some other embodiments diameter of the front end is 50% of the diameter of the back end.

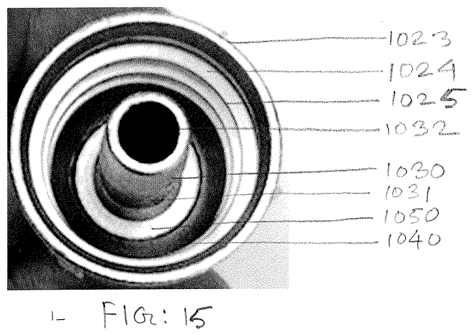

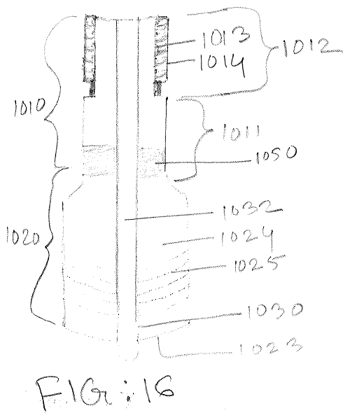

Multiple protrusions are formed in many different embodiments. As shown in FIG. 14, two protrusions (1450, 1451) are formed in one embodiment of the fitting. Three protrusions (1550, 1551, 1552) are formed in another embodiment as depicted in FIG. 15. These multiple protrusions are formed by using the same step (130). However, Different shapes of die are used for multiple protrusions. In one embodiment, one shape of die is used so that two protrusions are formed. Again, in another embodiment, another shape of die is used so that two protrusions are formed.

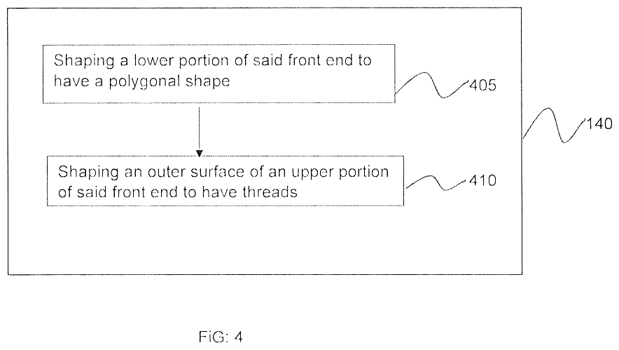

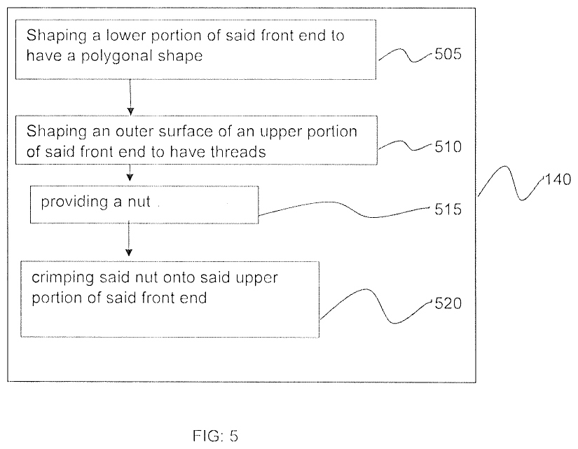

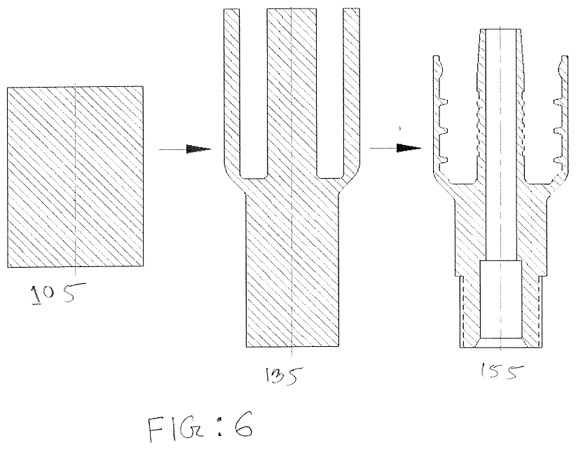

The front end is extended in the next step (140). This is done by using a stretching machine. The back end is hold still and pressure is applied on the front end. The front end now has an upper portion and a lower portion. The lower portion ends on the protrusion. As shown in FIG. 4, in some embodiments, step 140 further comprises the step of shaping a lower portion of said front end to have a polygonal shape (405) and the step of shaping an outer surface of an upper portion of said front end to have threads (410). Instead of a polygonal shape, the lower portion of said front end is cylindrical in some embodiments. Threading is done here by using a threading machine commonly available in the market. However, as shown in FIG. 5, in other embodiments, step 140 further comprises the step of shaping a lower portion of said front end to have a polygonal shape (505), the step of shaping an outer surface of an upper portion of said front end to have threads (510), the step of providing a nut (515), and the step of crimping said nut onto said upper portion of said front end (520). Instead of a polygonal shape, the lower portion of said front end is cylindrical in some embodiments. Threading is done here by using a threading machine commonly available in the market. In step 520, crimping of the nut onto the upper portion of the front end is done by utilizing a crimping machine. The nut is crimped in a way that it is permanently attached to the upper portion of the front end but flows freely around the threads. The nut is selected from the group comprising of hexagonal nut, polygonal nut, octagonal nut, circular nut, and quadrangular nut and square nut.

In step 515, nuts of different shapes including but not limited to square, hexagonal, pentagonal, circular and octagonal are provided in different embodiments. In those embodiments, nuts are crimped the same way as in step 520.

Coming back to FIG. 1, in step 145, the shaft and the front end are hollowed out uniformly which results in a hollow shaft being formed. This hollow shaft facilitates the flow of fluids.

Next, in step 150, an inner surface of said back end of the raised wall is shaped so that it has grooves. This is achieved by using a grooving machine commonly available in the market. In the last step (155), an outer surface of the hollow shaft is threaded by using a threading machine commonly available in the market. In most embodiments, both steps 150 and 155 are performed. However, in some embodiments, only step 150 is performed so that only an inner surface of said back end of the raised wall has grooves. Yet, in some other embodiments, only step 155 is performed so that only an outer surface of the hollow shaft has threads. Which embodiments to make, depends on the application.

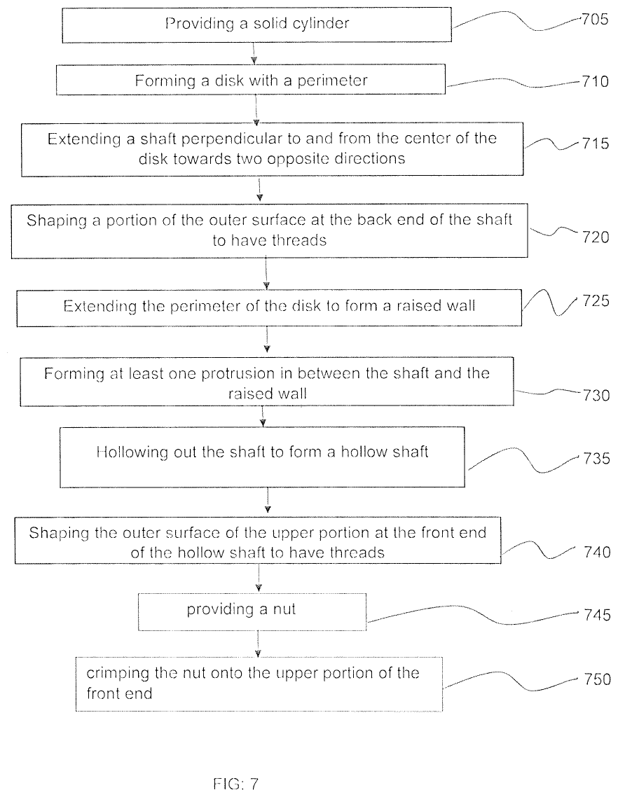

Starting from a solid cylinder, after each step described above, an interim structure is created before finally producing a finished product, which is a fitting. FIG. 6 depicts cross-section of each resulting interim structure after steps 105, 135, and 155 of the method in FIG. 1.

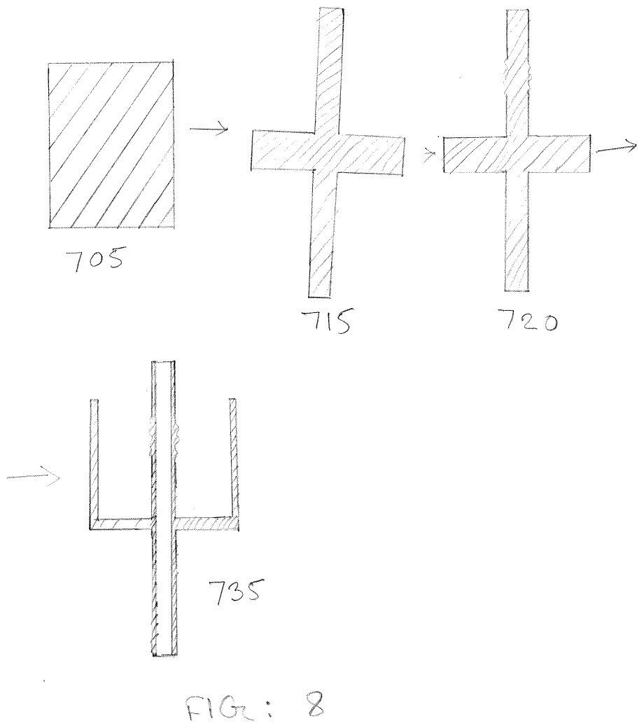

FIG. 7 depicts a method of making a fitting consistent with another embodiment of the instant invention. FIG. 7 shows the step (705) of providing a solid cylinder of malleable material. The cylinder is comprised of any malleable material suitable for use as a fitting. The cylinder is already annealed and lubricated. In most embodiments, the malleable material is a stainless steel. Fittings made with stainless still is mostly used in corrosive environments, especially if the fluid passing through the fitting, is corrosive. The applicant has advantageously found that 304 stainless steel provides the best performance in corrosive environments. In other embodiments the malleable material is a carbon steel. 1010 steal is mostly used for carbon steel embodiments. However, instead of 1010, 1020 is also used in some embodiments, where the carbon content is a little bit higher (approximately 0.2%). Herein, the cylinder of malleable material and all method steps for modifying said cylinder of malleable material will be described and portrayed as having a basic, curved cylindrical shape; that is to say that the ends of the cylinder are circles. However, the specific shape of the cylinder is not meant to be limited to this embodiment. In other embodiments, the outline of the cylinder is selected from the group comprising of a square, rectangle, triangle, pentagon, hexagon, octagon, and polygon. The specific shape of the cylinder of malleable material is a design choice well within the abilities of one of ordinary skill in the art. The cylinder is subjected to the various cold-forging and machining steps that will be described herein.

After the solid cylinder is provided (705), the cylinder is placed in a die and a high pressure is applied on the die. This way, a disk with a perimeter is formed (710). At the same time, a shaft is extended from the center of the disk towards two opposite directions (715). Now the shaft has two ends: a front end and a back end. Position of the disk with respect to the shaft varies from one embodiment to another embodiment. For example, in some embodiments, the disk is located at half of the total distance from the front end. In some other embodiments, the disk is located at three-fourth of the total distance from the front end. In yet some other embodiments, the disk is located at one fourth of the total distance from the front end. In yet another embodiment, the disk is located at two-fifth of the total distance from the front end. Which embodiment to use depends on the application, the designer's choice, cost and manufacturer's need. These different embodiments can be achieved by simply using different shapes of dies and different size of the cylinder. The thickness of the shaft as well as the disk also varies considerably depending on shape of the die and size of the solid cylinder.

Next, after step 715, a portion of the outer surface at the back end of the shaft is threaded (720). Threading is done here by using a threading machine commonly available in the market. Location and number of threads at the back end of the shaft depends on the application.

Next, the resulting interim product is placed in a die and a high pressure is applied (725). This results in the perimeter being extended towards the back end of the shaft and a raised wall is formed with an open back end and a closed front end. At least one protrusion is also formed at the same time (730). The raised wall contacts the shaft at the front end. They are shaped in a way that a hollow space is formed in between an outer surface of the shaft and an inner surface of the raised wall. The volume and shape of the hollow space is dependent on the shape of the die. Different shapes of the die results in different embodiments. It is ultimately dependent on the designer's choice, cost and manufacturer's need.

After step 730, the shaft is hollowed out uniformly to create a hollow shaft (735). The hollow shaft facilitates flow of fluids. Now, front end of the hollow shaft has an upper portion and a lower portion. In some embodiments, the lower portion of the front end is given a polygonal shape. Instead of a polygonal shape, the lower portion of said front end is kept cylindrical in some embodiments. In the next step, outer surface of the upper portion at the front end of the hollow shaft is threaded (740). Threading is done here by using a threading machine commonly available in the market. Number of threads at the front end of the hollow shaft depends on the application.

In some further embodiments, a nut is provided (745). These embodiments also include the step of crimping the nut onto the upper portion of the front end (750). In step 745, crimping of the nut onto the upper portion of the front end is done by utilizing a crimping machine. The nut is crimped in a way that it is permanently attached to the upper portion of the front end but flows freely around the threads. The nut is selected from the group comprising of hexagonal nut, polygonal nut, octagonal nut, circular nut, and quadrangular nut and square nut. Nuts of different shapes including but not limited to square, hexagonal, pentagonal, circular and octagonal are provided in different embodiments. In those embodiments, nuts are crimped the same way as in step 750.

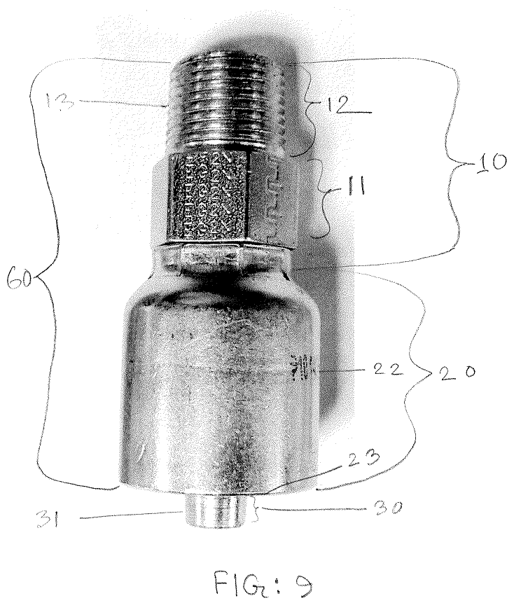

Starting from a solid cylinder, after each step described in FIG. 7, an interim structure is created before finally producing a finished product, which is a fitting. FIG. 8 depicts cross-section of each resulting interim structure after steps 705, 715, 720, and 735 of the method in FIG. 7.

FIGS. 9, 10, 11, and 12 depict a side view, a top view, a bottom view and a top-to-bottom cross-sectional view consistent with one embodiment of the fitting. The fitting comprises an outside housing (60), a hollow shaft (30), and at least one protrusion (50). As shown in FIG. 9, the outside housing has a front end (10), a back end (20) and an outer surface (22). The back end comprises a perimeter (23). The front end comprises a lower portion (11) and an upper portion (12). In this embodiment, shape of the lower portion is hexagonal. As depicted in FIG. 9, upper portion (12) of the front end (10) has threads (13). The hollow shaft (30) also has an outer surface (31).

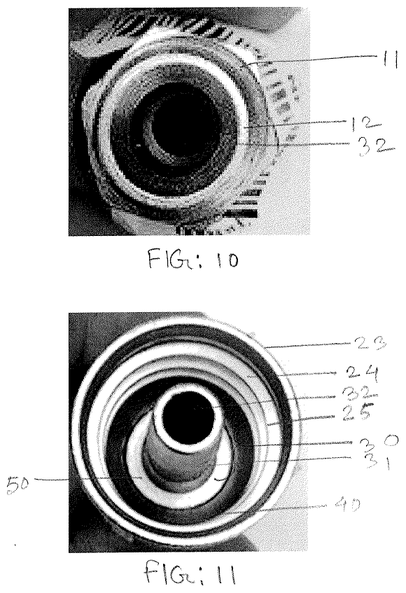

The top view in FIG. 10, consistent with the embodiment in FIG. 9, depicts the hollow space (32) inside the hollow shaft. It also shows the lower portion (11) and the upper portion (12).

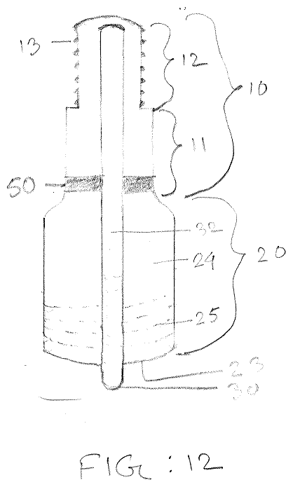

The bottom view in FIG. 11, consistent with the embodiment in FIG. 9, depicts the hollow space inside the hollow shaft (32), the hollow shaft (30), outer surface of the hollow shaft (31), perimeter of the outside housing (23), inner surface of the outside housing (24), grooves on the inner surface of the outside housing (25), the hollow space in between the outside housing and the hollow shaft (40), the protrusion (50).

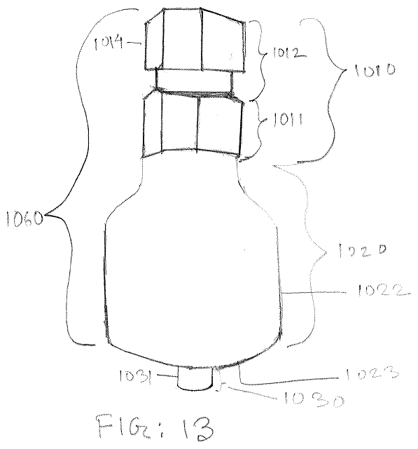

The top-to-bottom cross-sectional view in FIG. 12, consistent with the embodiment in FIG. 9, depicts the front end of the outside housing (10), lower portion of the front end (11) and upper portion of the front end (12), threads of the upper portion (13), the protrusion (50), back end of the outside housing (20), perimeter of the outside housing (23), inner surface of the outside housing (24), grooves on the inner surface of the outside housing (25), the hollow shaft (30), and the hollow space inside the hollow shaft (32).

As depicted in FIGS. 9, 10, 11, and 12, the hollow shaft penetrates through the outside housing in an axial direction. The front end has a smaller diameter than that of the back end. The protrusion extends from said outer surface of said hollow shaft towards said inner surface of said outside housing and forms a sealing. In most embodiments, the protrusion is generally perpendicular to said outside housing and said hollow shaft. In yet some embodiments, the protrusion is not perpendicular to said outside housing and said hollow shaft. In most embodiments, the protrusion touches inner surface of said outside housing. Still, in some embodiments, the protrusion does not touch inner surface of said outside housing.

The fitting is made of stainless steel in most embodiments. However, in one embodiment, the fitting is made of 1010 carbon steel. In another embodiment, the fitting is made of 1020 carbon steel. In yet different embodiments the fittings are made of different metal alloys.

In some embodiments the hollow shaft extends beyond the back end of the outside housing. In other embodiments, the hollow shaft ends before the end of the back end of the outside housing. In yet some other embodiments, the hollow shaft ends where the back end of the outside housing ends.

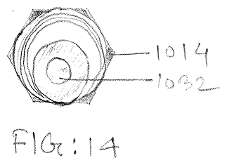

FIGS. 13, 14, 15, and 16 depict a side view, a top view, a bottom view and a top-to-bottom cross-sectional view consistent with another embodiment of the fitting. This embodiment of the fitting comprises an outside housing (1060), a hollow shaft (1030), a free-flowing nut (1014) and at least one protrusion (1050). As shown in FIG. 13, the outside housing has a front end (1010), a back end (1020) and an outer surface (1022). The back end comprises a perimeter (1023). The front end comprises a lower portion (1011) and an upper portion (1012). In this embodiment, shape of the lower portion is hexagonal. As depicted in FIG. 13, upper portion (1012) of the front end (1010) comprises a free-flowing nut (1013). The hollow shaft (1030) also comprises an outer surface (1031).

The top view in FIG. 14, consistent with the embodiment in FIG. 13, depicts the hollow space (1032) inside the hollow shaft. It also shows the free-flowing hexagonal nut (1014) attached on the upper portion of the front end.

The bottom view in FIG. 15, consistent with the embodiment in FIG. 13, depicts the hollow space (1032) inside the hollow shaft, the hollow shaft (1030), outer surface of the hollow shaft (1031), perimeter of the outside housing (1023), inner surface of the outside housing (1024), grooves on the inner surface of the outside housing (1025), the hollow space in between the outside housing and the hollow shaft (1040), the protrusion (1050).

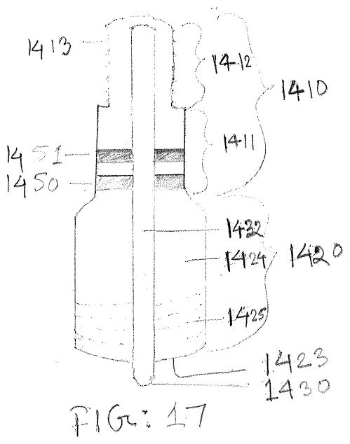

The top-to-bottom cross-sectional view in FIG. 16, consistent with the embodiment in FIG. 13, depicts the front end of the outside housing (1010), lower portion of the front end (1011) and upper portion of the front end (1012), threads on the upper portion (1013), the free-flowing hexagonal nut (1014), the protrusion (1050), back end of the outside housing (1020), perimeter of the outside housing (1023), inner surface of the outside housing (1024), grooves on the inner surface of the outside housing (1025), the hollow shaft (1030), and the hollow space (1032) inside the hollow shaft.

As depicted in FIGS. 13,14, 15, and 16, the hollow shaft penetrates through the outside housing in an axial direction. The front end has threads in this embodiment, which accommodates a nut. The nut is crimped onto the threads in this embodiment. The nut moves freely around the threads. In this embodiment, the nut is hexagonal. In other embodiments, the nut is selected from the group comprising of square nut, rectangular nut, triangular nut, pentagonal nut, octagonal nut, and polygonal nut. The front end has a smaller diameter than that of the back end. The protrusion extends from said outer surface of said hollow shaft towards said inner surface of said outside housing and forms a sealing. In most embodiments, the protrusion touches inner surface of said outside housing. Still, in some embodiments, the protrusion does not touch inner surface of said outside housing. In most embodiments, the protrusion is generally perpendicular to said outside housing and said hollow shaft. In yet some embodiment, the protrusion is not perpendicular to said outside housing and said hollow shaft.

The fitting with the free-flowing nut is made of stainless steel in most embodiments. However, in one embodiment, it is made of 1010 carbon steel. In another embodiment, it is made of 1020 carbon steel. In yet different embodiments the fittings are made of different metal alloys.

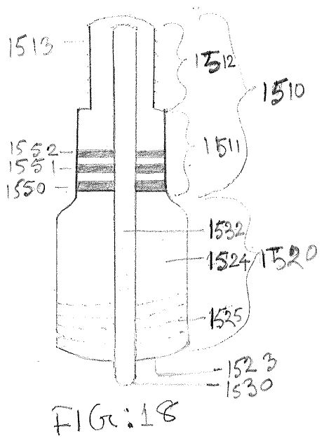

The top-to-bottom cross-sectional view in FIG. 17, consistent with one embodiment of the fitting, depicts the front end of the outside housing (1410), lower portion of the front end (1411) and upper portion of the front end (1412), threads on the upper portion (1413), first protrusion (1450), second protrusion (1451), back end of the outside housing (1420), perimeter of the outside housing (1423), inner surface of the outside housing (1424), grooves on the inner surface of the outside housing (1425), the hollow shaft (1430), and the hollow space (1432) inside the hollow shaft.

As depicted in FIG. 17, the hollow shaft penetrates through the outside housing in an axial direction. The front end has a smaller diameter than that of the back end. The protrusions extend from said outer surface of said hollow shaft towards said inner surface of said outside housing and form sealings. In most embodiments, the protrusions are generally perpendicular to said outside housing and said hollow shaft. In yet some embodiments, the protrusions are not perpendicular to said outside housing and said hollow shaft. In most embodiments, the protrusions touch inner surface of said outside housing. Still, in some embodiments, the protrusions do not touch inner surface of said outside housing.

The top-to-bottom cross-sectional view in FIG. 18, consistent with another embodiment of the fitting, depicts the front end of the outside housing (1510), lower portion of the front end (1511) and upper portion of the front end (1512), threads on the upper portion (1513), first protrusion (1550), second protrusion (1551), third protrusion (1552), back end of the outside housing (1520), perimeter of the outside housing (1523), inner surface of the outside housing (1524), grooves on the inner surface of the outside housing (1525), the hollow shaft (1530), and the hollow space (1532) inside the hollow shaft.

As depicted in FIG. 18, the hollow shaft penetrates through the outside housing in an axial direction. The front end has a smaller diameter than that of the back end. The protrusions extend from said outer surface of said hollow shaft towards said inner surface of said outside housing and form sealings. In most embodiments, the protrusions are generally perpendicular to said outside housing and said hollow shaft. In yet some embodiments, the protrusions are not perpendicular to said outside housing and said hollow shaft. In most embodiments, the protrusions touch inner surface of said outside housing. Still, in some embodiments, the protrusions do not touch inner surface of said outside housing.

In some embodiments the hollow shaft extends beyond the back end of the outside housing. In other embodiments, the hollow shaft ends before the end of the back end of the outside housing. In yet some other embodiments, the hollow shaft ends where the back end of the outside housing ends.

Prior arts teach using O-ring sealing for a fitting. They also teach combining different with joints and seals. However, those conventional fittings do not ensure withstanding high pressure and high temperature. Especially, O-ring sealings are most vulnerable. They fail at significantly lower pressures than the steel burst pressure. The pressure rating for O-ring sealings is approximately 1-10 MPa, whereas Steel can comfortably withstand 100 MPa. That is why applicant replaced O-ring sealing with Stainless Steel/Carbon Steel/Metal Alloy protrusion. Also, there is no joint/seams in Applicant's fitting. The single piece main body ensures best performance and longevity.

While the present invention has been particularly described, it is evident that many alternatives, modifications and variations will be apparent to those skilled in the art in light of the foregoing description. It is therefore contemplated that the appended claims will embrace any such alternatives, modifications, and variations as falling within the true scope and spirit of the present invention.

What is claimed:

1. A method of making a fitting comprising the steps of:
providing a solid cylinder having a perimeter;
extending said perimeter to form a raised wall;
wherein said raised wall has a front end and a back end;
extending a shaft from said front end toward said back end in an axial direction;
shaping said raised wall and said shaft to form a hollow space in between an outer surface of said shaft and an inner surface of said raised wall; wherein said raised wall and said shaft are integrally connected at said front end as a single piece;
hollowing out said shaft and said front end to form a hollow shaft.

2. The method of claim 1, further comprising the step of providing a diameter of said front end to be less than a diameter of said back end.

3. The method of claim 1, further comprising the step of forming at least one protrusion in between said shaft and said raised wall at said front end.

4. The method of claim 1, further comprising the step of extending said shaft beyond said back end of said raised wall.

5. The method of claim 1, further comprising the step of extending said front end.

6. The method of claim 5, further comprising the step of shaping a lower portion of said front end to have a polygonal shape.

7. The method of claim 5, further comprising the step of shaping an outer surface of an upper portion of said front end to have at least one thread.

8. The method of claim 1, further comprising the step of shaping an inner surface of said back end to have at least one groove.

9. The method of claim 1, further comprising the step of shaping an outer surface of said hollow shaft to have at least one thread.

10. A method of making a fitting comprising the steps of:
providing a solid cylinder having a perimeter;
extending said perimeter to form a raised wall;
wherein said raised wall has a front end and a back end;
extending a shaft from said front end toward said back end in an axial direction;
shaping said raised wall and said shaft to form a hollow space in between an outer surface of said shaft and an inner surface of said raised wall;
wherein said raised wall and said shaft are integrally connected at said front end as a single piece;
providing a diameter of said front end to be less than a diameter of said back end;
forming at least one protrusion in between said shaft and said raised wall at said front end;
hollowing out said shaft and said front end to form a hollow shaft.

11. The method of claim 10, further comprising the step of extending said front end.

12. The method of claim 11, further comprising the step of shaping a lower portion of said front end to have a polygonal shape.

13. The method of claim 12, further comprising the step of shaping an outer surface of an upper portion of said front end to have at least one thread;

14. The method of claim 13, further comprising the step of providing a nut and crimping said nut onto said upper portion of said front end;
wherein said nut is permanently attached to said upper portion of said front end but flows freely around said at least one thread.

15. The method of claim 10, further comprising the step of extending said shaft beyond said back end of said raised wall.

16. The method of claim 10, further comprising the step of shaping an inner surface of said back end to have at least one groove and the step of shaping an outer surface of said hollow shaft to have at least one thread.

17. A fitting comprising:
an outside housing, having an inner surface and an outer surface;
a hollow shaft, having an inner surface and an outer surface;
wherein said outside housing has a front end with a smaller diameter and a back end with a larger diameter;
wherein a diameter of said hollow shaft is smaller than said larger diameter of said back end of said outside housing;
at least one protrusion extending from said outer surface of said hollow shaft toward said inner surface of said outside housing to form a sealing;
wherein said at least one protrusion is located in between said front end and said back end and is generally perpendicular to said outside housing and said hollow shaft.

18. The fitting of claim 17, wherein said fitting further comprises a second protrusion which extends from said outer surface of said hollow shaft toward said inner surface of said outside housing to form a sealing.

19. The fitting of claim 17, wherein said hollow shaft extends beyond said back end of said outside housing.

20. The fitting of claim 17, wherein a portion of said outer surface at said front end of said outside housing is threaded to attach a securing mechanism and a portion of said inner surface at said back end of said outside housing is grooved to attach a securing mechanism.
